(19) United States
(12) Patent Application Publication
(10) Pub. No.: US 2025/0304378 A1
(43) Pub. Date: Oct. 2, 2025

(54) SYNCHRONIZING CONDITIONS FOR CONVEYOR BELT MONITORING

(71) Applicant: ContiTech Deutschland GmbH, Hannover (DE)

(72) Inventors: Jack Bruce Wallace, Powell, OH (US); Eugen Wagner, Hannover (DE); Jacques Frederick Basson, Braga (PT); Atrayee Neog, Hamburg (DE)

(73) Assignee: ContiTech Deutschland GmbH, Hannover (DE)

(21) Appl. No.: 18/617,193

(22) Filed: Mar. 26, 2024

(51) Int. Cl. B65G 43/02

(52) U.S. Cl. CPC B65G 43/02; B65G 2203/0275; B65G 2203/0283

(57) ABSTRACT

A conveyor belt monitoring system is disclosed for synchronizing belt condition, conveyor system condition, and process conditions. The system includes a plurality of sensors for measuring belt conditions, process conditions, and conveyor structure conditions, providing workflow data, and one or more location sensors for belt position data. A memory storage and interface are provided, along with circuitry comprising processors to synchronize process data, belt condition data, conveyor system data, and location data into a synchronization data set. The system can detect events based on the synchronization data and operating process tolerances, correlate the detected events with the synchronization data as correlated data, and analyze the correlated data for improved monitoring and maintenance of conveyor belt systems.

### FIELD

The field to which the disclosure relates is rubber products, such as conveyor belts, exposed to harsh conditions, and in particular, the use of synchronizing of the specific conveyor belt position under various structural and process conditions to analyze conveyor belt events and make recommendations to resolve the generator of those events.

### BACKGROUND

The subject matter related generally to conveyor belts and, more particularly to conveyor belt monitoring.

Conveyor belt monitoring systems have been utilized in various industries to monitor the condition of conveyor belts, process conditions, and conveyor system conditions. These systems typically include sensors that measure parameters such as belt tension, speed, temperature, vibration, and alignment to provide data on the overall health and performance of the conveyor system. Additionally, sensors may be employed to monitor process conditions such as material flow rates, product quality, and environmental factors that can impact the conveyor system's operation.

### BRIEF DESCRIPTION OF THE DRAWINGS

FIG. 1 is a diagram illustrating a system 100 for conveyor belt damage detection, monitoring and analysis in accordance with one or more embodiments.

FIG. 2 is a front view of the conveyor belt system 100 in accordance with one or more aspects.

FIG. 3 is a top view of the conveyor belt system 100 in accordance with one or more aspects.

FIG. 4 is a diagram further illustrating the conveyor belt system 100 in accordance with one or more aspects.

FIG. 5 is a diagram further illustrating the site controller 404 in accordance with one or more aspects.

FIG. 6 is a diagram further illustrating the conveyor data 406 in accordance with one or more embodiments.

FIG. 7 is a diagram illustrating a system for conveyor belt damage monitoring in accordance with one or more embodiments.

FIG. 8 is a flow diagram illustrating a method of generating an action report in accordance with one or more embodiments.

FIG. 9 is an example of an event and action in accordance with one or more embodiments.

FIG. 10 is a diagram illustrating various references for conveyor belts that can be utilized in accordance with one or more embodiments.

FIG. 11 is a diagram illustrating example conditions that can be employed with the system 100 in accordance with one or more embodiments.

### DETAILED DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, with the understanding that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one, and the singular also includes the plural unless otherwise stated.

The terminology and phraseology used herein is for descriptive purposes and should not be construed as limiting in scope. Language such as “including”, “comprising”, “having”, “containing”, or “involving”, and variations thereof, is intended to be broad and encompass the subject matter listed thereafter, equivalents, and additional subject matter not recited.

Also, as used herein, any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

A heavy-duty conveyor belt can be employed for the purpose of transporting products and material. The conveyor belts so employed may be long, for example, in the order of miles, and represent a high-cost component of an industrial material handling operation. Such conveyor belts can be as large as ten feet wide, and possibly as thick as three inches. Typically, the main belt material is a moderately flexible elastomeric or rubber-like material, and the belt is typically reinforced by a plurality of longitudinally extending metal cables or cords, which are positioned within the belt and extend along the length thereof. Such conveyor belts are often used to transport bulk material below and/or above ground, for example, in mining applications. The conveyor belts and respective drives and supporting structure are exposed to harsh conditions associated with the processing and movement of the material being mined.

It is important to monitor the condition of the conveyor system and conveyor belt together with possible changes to the conveyor or material processes. Typically, a mine will monitor the condition of the conveying process with sensors that detect extreme conditions, such as when the belt is tracking into the structure of the conveyor or when the belt has too much material (overload condition) or when there is slip between the belt and the drive pulley. These are all extreme conditions which will normally result in the conveyor being stopped and a downtime event. If these conditions are frequent enough or are causing damage to the conveyor belt or structure, the operator may then look at what may be causing the condition to occur, and often requests external support to help determine what can be done to avoid the condition from occurring. Typically, in this case a consultant would initiate a study to explore the process and determine what is happening in the process to generate the extreme condition. The consultant will offer the customer advice on how to prevent the extreme condition from occurring. Often the time to resolution is dependent on the experiences of the consultant and the output may include some subjective and biased information depending on the consultant's knowledge and experiences.

The proposed solution is a means to generate belt positional information using at least one reference point, and generating at least one synchronizing signal associated with at least one of the reference points as they pass a specific location along the conveyor system. By using the synchronizing signal, time, and physical location of a given position of the belt, it then becomes possible to analyze a given event observation against other belt monitoring sensors, process monitoring sensors or conveyor structure monitoring sensors. The aim of this analysis is to correlate the events registered on any of those sensors located along the length of the conveyor with one another and with the conveyor belt position. By assessing the strongest correlation, it is possible to narrow the potential sensor data to identify what generated the event. By incorporating feedback, based on corrective action and operational validation, it is possible to document the success of the algorithm. Additionally with this feedback, it is possible to implement machine learning algorithms to improve the performance and accuracy of the solutions circuitry to generate strongly correlated results with recommended action items.

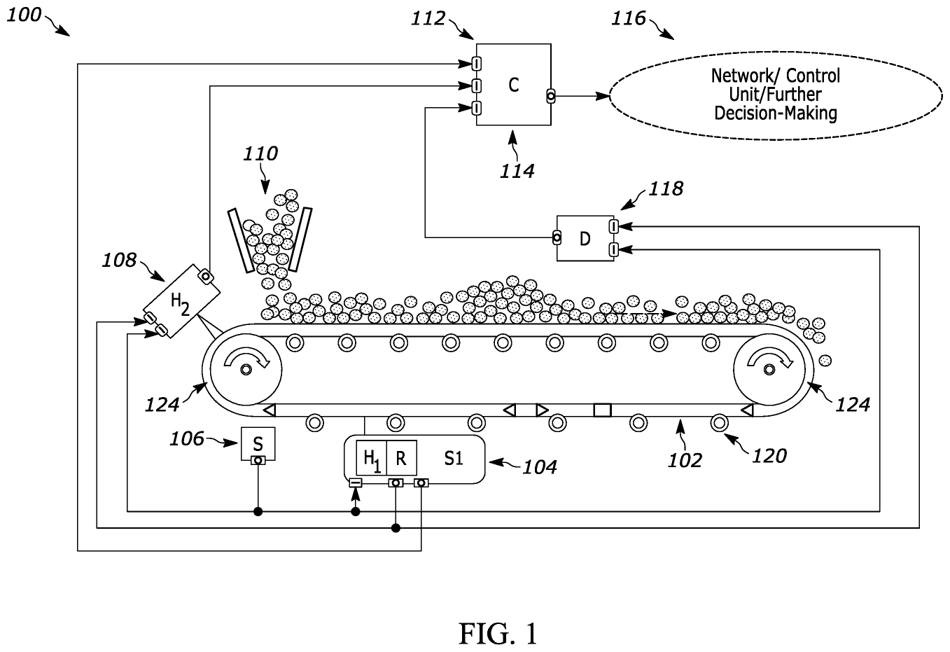

One or more embodiments can be employed that include a quantitative data driven solution that utilizes a synchronization signal based on the position of a specific point on the belt (reference point) relative to the conveyor structure location (along the length of the conveyor structure) and/or process components (loading chute, drives, discharge, turnovers, etc.). The belt reference or references to be detected by a sensor (FIG. 1) that provides a synchronization signal(s) can be based on a specific magnetic signature from a specific reference splice, a magnet or magnetic bar code(s), an optical reference (splice or brand), a topographical reference (embedded brand or marking), an RFID tag or other element embedded in the belt, or some other detectable reference point(s) on the conveyor belt. Having data that is synchronized with the belt position and condition, along with the process and structural conditions, it is possible to isolate what generated the “out of norm” and/or “extreme” condition. This is achieved using correlated data from the different conveyor belt, process and structural monitoring datasets. A synchronization between the different datasets can be established by knowing the position of the conveyor belt, position along the conveyor structure, the process condition, and the “out of norm” or “extreme” events. Through analysis of these datasets, it becomes possible to recommend potential resolutions for these events. Resolution of the “out of norm” and/or “extreme” events is important as the events could generate further degrading damage to the conveyor belt, conveyor structure or impact the capacity of the conveyance process. Given that mine sites often use programmable logic controllers (PLCs) to monitor individual sensor inputs to identify specific “extreme” conditions, or events, as they occur, they often only have the event logged by time. These conditions are not normally referenced to other operating conditions that may have preceded or led-up to the generation of the “extreme” condition. By capturing these extreme events as inputs, as well as the sensor operational data directly such that the process norms can be statistically documented, additional process analysis can be done to either statistically identify “out of norm” events or events outside user-defined tolerances. Identifying “out of norm” events that are not necessarily of the same magnitude as “extreme” events that often generate stops to the conveying processes, it may be possible to predict and react prior to the generation of the catastrophic event and, thus, avoid the larger catastrophic events.

The proposed techniques can align or synchronize the belt position with the sensor datasets at different locations along the length of the conveyor system that monitor the conveyor belt, process and conveyor structure. By analyzing the belt condition, along with the condition of the structure and process datasets, it is possible to monitor the combined datasets over time with statistical or user-defined tolerances to identify “out of norm” conditions. These “out of norm” conditions, along with the “extreme” conditions, would be used to trigger the rendering of a combined dataset from the workflow datasets, which is then subject to a correlation analysis with the belt position and time in order to generate a correlated data sub-set. The strongest correlations can then be selected for event generator identification. In the following examples, the “out of norm” and/or “extreme” condition or event could relate to the conveyor belt, process or conveying structure.

Conveyor belt condition monitoring sensors include those systems that monitor: the condition of the steel cords or carcass of the conveyor, the wear of the conveyor belt covers, the cover damage, the condition of the belt splices, etc. Process condition sensors monitor: the loading condition of the belt, the lateral position of the belt, belt slip, energy usage, material characterization, etc. The structural condition includes monitoring of: structural alignment, idler condition, pulley condition, pulley lagging, cleaner condition, scraper condition, plow condition, skirtboard condition, etc.

In one example, the site may have an issue with belt tracking. In this case the lateral position of the conveyor belt relative to the conveyor structure is an extreme operating condition and the event would have been detected by a limit switch or potentially an ultrasonic proximity sensor. This belt misalignment could be generated by a conveyor structural element being out of alignment (skewed pulley or idler set), a misaligned or damaged splice in the conveyor belt, contamination on the idlers or pulleys on the conveyor system or a process related issue, such as off-center loading. To determine what is generating the extreme condition, it is important to isolate the parameters by synchronizing to the specific belt location at the specific structural location, and to align the event timing with the detection timing given the spatial separations of the place of the event and the location and time of the detection. Knowing the position of the sensor that detected the misalignment along the conveyor structure position and the process state at the time when the event occurs, it is possible to determine if the event is occurring at a frequency consistent with the length of the belt at the specified location along the structure regardless of the process condition, such as loaded or unloaded. With this information, it is more likely that a belt splice issue or belt damage could be the generator of the detected behaviour. Alternatively, if the belt misalignment was present independent of belt position or process condition, the misalignment of a structural element should be explored as the generator. Finally, if the misalignment only occurs during certain loading conditions, there is potential the misalignment is being generated by an off-center load or other process related parameter.

Conveyor belt systems are used in a variety of applications to transfer material from one location to another. Conveyor belt systems are typically subjected to a variety of environmental conditions, process conditions, belt conditions and the like, which can result in damage. Further, use over time can also result in damage.

One or more embodiments are described that synchronize health conditions, process conditions, belt conditions and the like to detect triggering events.

FIG. 1 is a diagram illustrating a system 100 for conveyor belt damage monitoring in accordance with one or more embodiments. The system 100 is provided for illustrative purposes and it is appreciated that suitable variations are contemplated.

The system 100 synchronizes health conditions, process conditions, belt conditions and the like to detect triggering events.

The system 100 includes a conveyor belt 102, rollers or idlers 120, pulleys 124, a drive unit turning one of the pulleys, a conveyor support frame, a chute 110 and a controller 116.

The conveyor belt 102 moves materials or medium from one point to another. Conveyor belts are usually made of rubber or a similar material and are looped around a series of rollers 120.

The rollers or idlers 120 are generally located along the conveyor to support and guide the belt. The rollers on the side of the conveyor that is carrying the material are referred to as troughed idlers. The rollers on the return side of the conveyor are referred to as return idlers.

The drive unit is responsible for providing the motion that moves the conveyor belt. It typically includes an electric motor, a gearbox, and sometimes a drive control system. Depending on the length of the conveyor, one or more drive unit(s) can be connected to one or more of the larger pulley(s) 124 to drive the conveyor belt through its rotational cycle and move material from loading point to discharge.

The structural frame supports the conveyor system, which holds all the components in place over the length of the conveyor system.

The chute 110 facilitates depositing material onto the belt 102.

The solution controller 116 incorporates the circuitry and related algorithms that correlates the combined datasets for generation of recommendations on detected events.

The system 100 also includes monitoring components including, but not limited to a magnetic flux leakage sensor array 104 with a computational unit and database, a tachometer 106, a surface laser scanner 108, an interface or IPC 112, and a volume flow measurement device 118. It is appreciated that suitable variations in monitoring components are contemplated.

The controller 116 and/or the computational unit 104 are configured to measure unique identifiers, markers, or patterns (M) and the like of the belt to determine positions. The unit 104 can have its own data processing, IO and communication capabilities. The belt 102 can include one or more unique identifiers along the conveyer belt. The identifier can be a marker or pattern (also intrinsic). The identifiers move together with the belt and allow for the identification of a reference position along the conveyor belt.

The tachometer 106 measures the speed of the conveyor 102. It is appreciated that it could also be a part of system together with combinations of other units. In one example, the tachometer provides and communicates a movement speed signal.

The controller 116 receives data from at least two sources, processes the data and read/writes historical information to a database in order to be able compare and correlate the data with each other and derive conclusions from these correlations.

Based on the provided data and the positions, the controller 116 is able to correlate the data and compare it to previously measured values for the area/position of the belt to provide more value.

The controller 116 is configured to monitor conditions of the belt 102 including, but not limited to belt surface damage, splices, rip detection, carcass condition and the like.

The volume flow device 118 is configured to measure process conditions including, but not limited to load volume, environmental conditions, temperature, process influences, stresses, strains and the like.

The monitoring devices can also include vibration sensors, temperature sensors, acoustic sensors and the like.

Various factors are considered including location, positions, distances and areas for determining events.

### Location

Where a device is located along the conveyor length, independent from the traveling belt. The location is typically a fixed location along the length of the conveyor.

### Positions

Belt positions in relation to devices. The belt movement can be monitored using a proximity sensor located at the tail or head pulley of a conveyor structure that counts target pulses to determine the rotation of the pulley. Knowing the circumference of the pulley allows for the belt displacement to be calculated. The structural location of the proximity sensor could be described as at Om on the conveyor system. The reference belt position change while the belt travels. For example, if a reference position on the belt travels at a speed of 2 m/s and passes device A at time t=0s, the same belt position will pass device B (distance from A=10 m) after 5s.

### Distances

Measurements of belt travel distances between devices, that are placed to measure, detect, or monitor physical features on or about the belt or influencing the belt's condition in any way.

### Areas

Positions on the belt with a delta because of uncertainties. Measuring an event at one particular position along the belt is likely to have effect on surrounding area. Correlations need to take this into account.

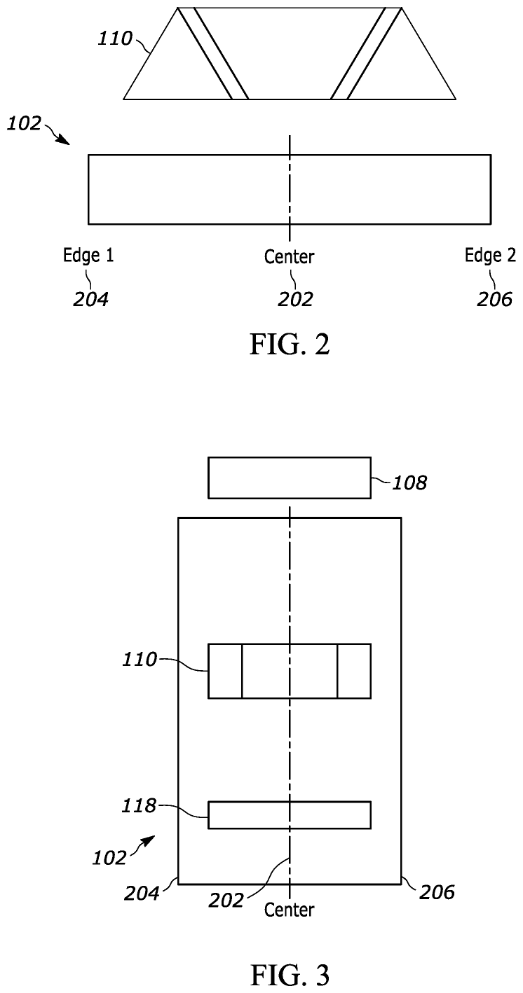

FIG. 2 is a front view of the conveyor belt system 100 in accordance with one or more aspects.

The view shows edge regions 204, 206 and a center region 202 of the belt 102.

FIG. 3 is a top view of the conveyor belt system 100 in accordance with one or more aspects.

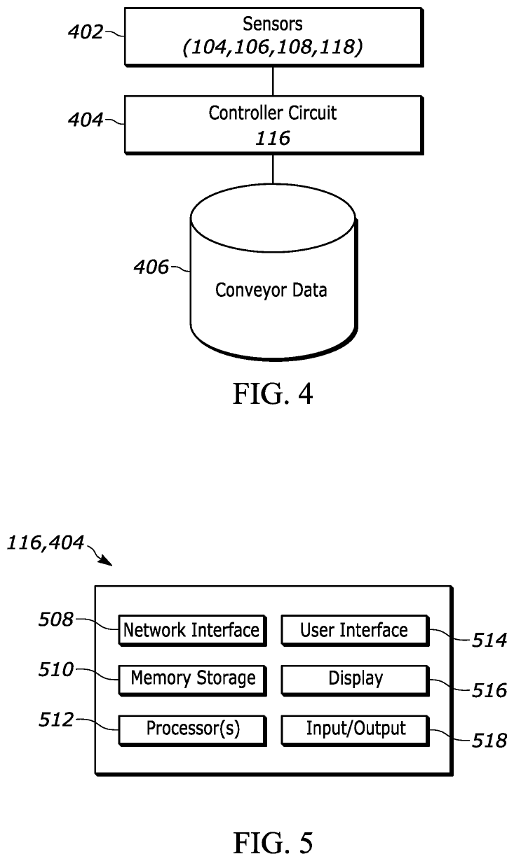

FIG. 4 is a diagram further illustrating the conveyor belt system 100 in accordance with one or more aspects.

The system 100 includes sensors 402 connected to a controller (site controller and/or device controller 116) 404 and connected to conveyor data 406. The conveyor data 406 can include prior condition data.

FIG. 5 is a diagram further illustrating the site controller 404 in accordance with one or more aspects.

The controller 116, 404 includes, for example, a network interface 508, a memory storage 510, one or more processors 512, a user interface 514, a display 516 and an input 518.

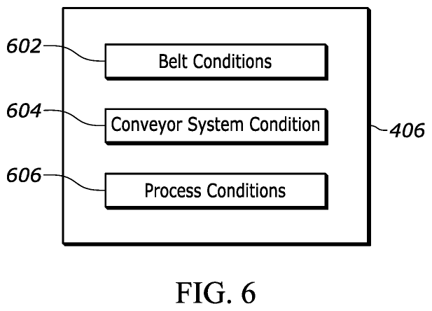

FIG. 6 is a diagram further illustrating the conveyor data 406 in accordance with one or more embodiments.

In this example, the conveyor data 406 includes belt conditions 602, conveyor system conditions 604 and process conditions 606.

The belt conditions 602 can include belt age, material composition, belt temperature, belt damage, and the like.

The conveyor system conditions 604 can include transport speed, load and/or loading, and the like.

The process conditions 606 can include temperature, vibration and the like.

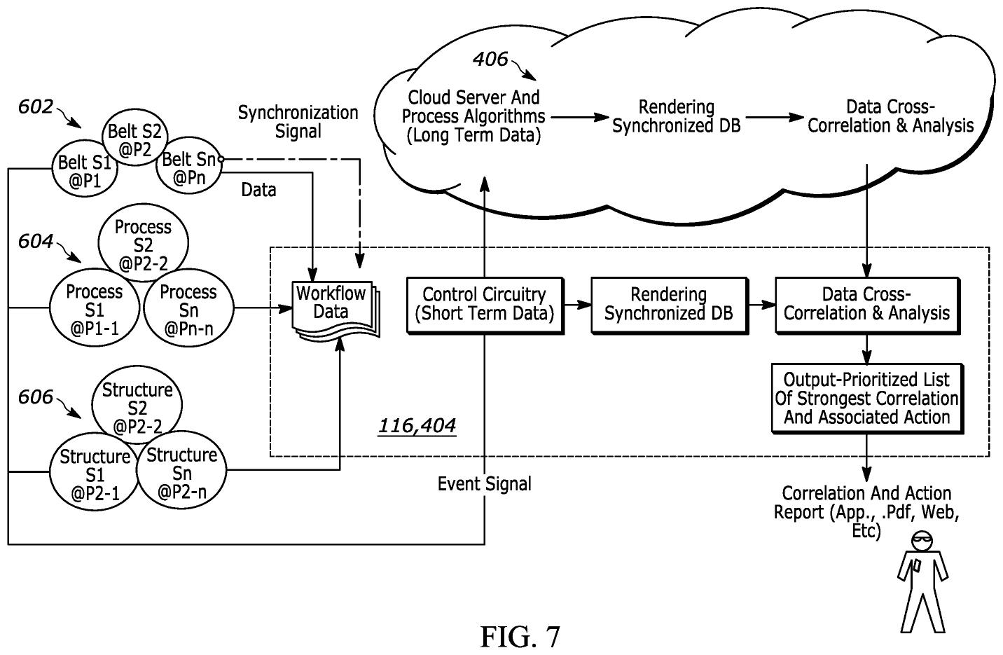

FIG. 7 is a diagram illustrating a system for conveyor belt damage monitoring in accordance with one or more embodiments. The system is provided for illustrative purposes and it is appreciated that suitable variations are contemplated.

The belt conditions 602, process conditions 606 and structure/conveyor system conditions 604 can be referred to as data or workflow data. The workflow data is provided to the controller 116, 404.

The controller 404 includes a device interface 508, 514 and a rendering synchronized database, also referred to as a short-term database.

The device interface receives the workflow data and can pass at least a portion of the workflow data to a long-term database.

The long-term data is analyzed to identify anomalies or out of norm events, that may or may not have been detected by the site's sensors.

The long-term data is stored in the long-term database.

Upon event detection, the long-term data is rendered and analyzed for strong correlations between the event and the different sensor data sets based on conveyor belt condition, conveyor condition and process conditions.

The workflow data or short-term workflow data is collected with the synchronization signal to create a local database by the controller 404. The data from the controller can be communicated to the cloud to create the long-term dataset on a cloud database. The short-term workflow data is synchronized upon an event detection and analyzed to determine strong correlations within the data.

The controller 404 can employ long-term analysis and short-term analysis to generate an output as a prioritized list of strongest correlations and associated actions for each of these strongest correlations.

The output can be provided as an action report via interfaces 508, 514 display 516 and the like.

The action report can be provided and/or formatted using the system HMI, a mobile device (phone) app, application, document exchange format (pdf), web and the like.

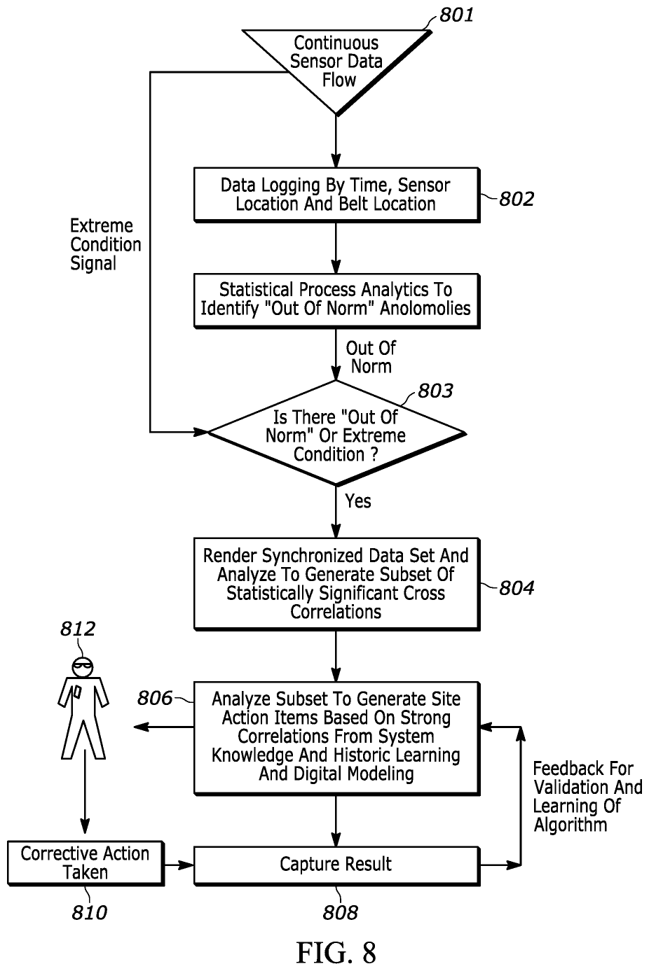

FIG. 8 is a flow diagram illustrating a method of generating an action report in accordance with one or more embodiments. The method is provided for illustrative purposes and it is appreciated that suitable variations are contemplated.

Sensor data is obtained or provided using one or more sensors at 801.

The sensor data can be logged by time, sensor location and belt location at 802.

A check for out of normal condition is performed at 803.

A data subset of statistically significant correlations is rendered at 804.

The data subset is analyzed to generate an output and action items based on the rendered correlations at 806.

The action items are captured as a result at 808. Additionally, the captured result can be used as feedback to block 806, for example, to adjust analysis and/or learning.

Corrective action can be taken at 810.

An entity, such as a user or device can perform the corrective action.

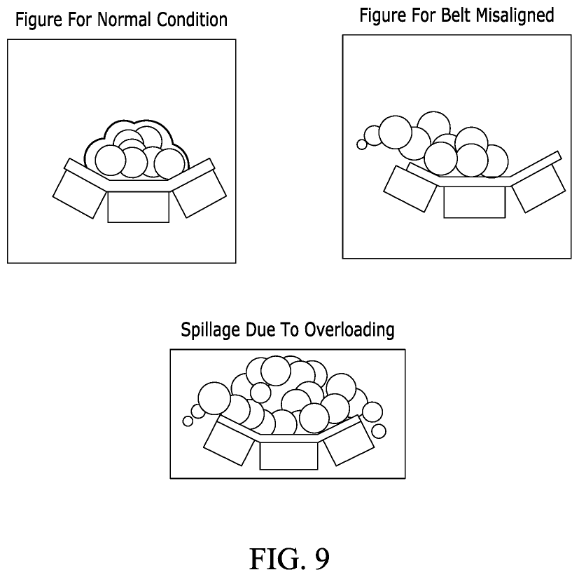

FIG. 9 is an example of an event and action in accordance with one or more embodiments.

FIG. 9 shows a first process condition having normal loading on the left side of the figure.

A misaligned condition is shown on the right side of the figure, and is shown having material spilling off of a side of a conveyor belt.

An overloaded condition is shown on the bottom side of the figure. The overloaded condition has material spilling on both edges of the belt.

The system 100 is configured to allow for numerous belt monitoring sensors, process monitoring sensors and conveyor system structural and component monitoring sensors to feed into a master dataset (workflow). This can be combined with the belt reference via synchronization signals and out of norm event notifications or extreme event notifications from the site PLC. Events recorded with any of the sensors monitoring the belt, process or system can also be incorporated into the dataset. A statistical analysis of the master dataset, and/or defined tolerance settings, can then be performed. This master dataset can be stored locally, and/or in the cloud. When an event is detected, the synchronization process is initiated, where a synchronized data set is generated for analysis. This can be done both for short-term data on a local device and potentially long-term data analysis in the cloud level. The synchronized dataset is then analyzed to provide those conditions that correlated strongly with the observed behavior and provides this output to the user along with recommendations for corrective action. The operator's feedback to the system on a given corrective action taken and validation of the event generator can enable higher-level machine learning algorithms to provide an active learning capability to the system's algorithm. Thus, the algorithm can be trained on the type of event detected and the synchronized data that is analyzed to create corrective action recommendations. Feedback on the corrective actions taken and the operator's validation of the event generator can then be incorporated into the algorithm, allowing it to learn to generated more accurate corrective action recommendations in real time.

The integration of a digital twin model of the conveyor system facilitates a high-level analysis of the correlated data with the observations made over time, and could be used to validate and prioritize the recommended action items. The digital twin could also be used to generate more robust predictions from the machine learning algorithm, by feeding it the data and specifications of the conveyor system, as well as evaluated responses from the recommended action items which are reflected and stored in the digital twin model. The digital twin could also be used for optimization and predictive insights based on the changing conditions of the conveyance processes and the system performance as determined by the event triggers.

As an example, consider damage to the conveyor belt's reinforcing steel cords at a known location from the belt reference point. In this case, the new damage event would be detected on a cord monitoring device that would generate an alarm or notification indicating that new damage was detected, and the location on the conveyor belt where it was located. Here the primary device would be monitoring the condition of the steel cords and detecting any steel cord damage being generated. By knowing the damage location relative to the reference position (synchronization position), along with the time of the steel cord damage event, and synchronizing the datasets for the conveyor structural health and process conditions during that time, it is possible for the system to determine what conditions may have led to the generation of the damage.

As a further example, monitoring the process condition, such as the loading level and position of the load relative to the edge of the belt, could indicate that the process was in a condition that allowed for material spillage to occur. This could be due to an overload condition (see, FIG. 9) where too much material was loaded onto the belt and material is potentially spilling over the belt onto the structure on both sides of the conveyor. Alternatively, it could be due to a belt misalignment condition where the material spillage occurs during normal loading due to the belt not being positioned properly (FIG. 9). The misalignment condition could also be caused by a belt related issue (damaged belt or misaligned splice) generating a periodic belt displacement condition, which results in the right conditions for material spillage.

In another example, a cord damage event may be generated by larger than normal ore striking the top cover of the belt during the loading process, which could be detected by a load monitoring sensor. In this case, monitoring of the ore size being transported at the time of the damage event's generation allows for the damage location and occurrence time of to be correlated with the process event that created the damage. By including a second belt condition sensor that monitors the conveyor covers for damage and synchronizing its data using the synchronization signal, it is possible to correlate this information with the larger datasets. The addition of this sensor data allows for identification of any belt surface damage that may be associated with the cord damage and thus allow for determining which side of the conveyor is damaged. This provides the system with the ability to differentiate a loading generated issue that damages the top cover of the conveyor belt, from a trapped material issue that damages the pulley cover of the conveyor belt. This provides a means to isolate the root cause of the out of norm or extreme event (critical alarm) issue that was detected, in this case the generation of cord damage. Given the loading conditions and the characteristics of the belt condition data (cord and surface damage) it is possible to determine what conditions were present when the damage event was generated.

In this example, the proposed solution provides a means to align all of the incoming sensor data for the generation of insights on the conveyor belt condition. This requires synchronization to the belt reference position and damage location (in terms of when it occurred and its location). Then the synchronized conveyor condition and conveying process information needs to be correlated with the generated damage events. Analysis of the synchronized and correlated data is performed to identify potential insights into the causes of the damages. Recommended actions to address these issues can be generated, which will extend the life of the conveyor system, thus improving productivity and reducing the total cost of transporting material.

For the analysis, correlations between the damage and the incoming synchronized sensor data are found. The dependence of the damage or event on the synchronized datasets can be analyzed using statistical algorithms and techniques. Linear relationships between any sensor data and the damage will be analyzed using Pearson's correlation coefficient. Spearman's rank correlation and Kendall's tau are non-parametric correlation measures for non-linear dependencies and a dataset with a possibility of many outliers. Although certain relations between the sensor data and the damage event are direct and immediate, certain interdependencies develop over time. These can be analyzed with the help of temporal correlation techniques to understand trends over extended periods of time. Machine learning algorithms such as Support Vector Machines, Ensemble Methods and techniques like Explainable AI are useful not just to unravel complex, interconnected relationships between a network of sensor data and their influence on certain events, but also to explain the causes behind certain interdependencies.

The data and specifications from conveyor system modelling algorithms that generate a digital twin of the conveyor system are utilized to feed additional data to the algorithm. The algorithm already utilizes the correlation analysis and a machine learning algorithm, which is trained on the changing conveyor condition data, to predict the conveyor model performance against belt, structure and process changes that are occurring. The digital twin is then used to validate the predicted observations and for prioritizing recommendations based on criticality and feasibility. Additionally, the data sets collected to train the machine learning algorithm along with the correlation analysis can be used to improve the digital twin model of the conveyor system.

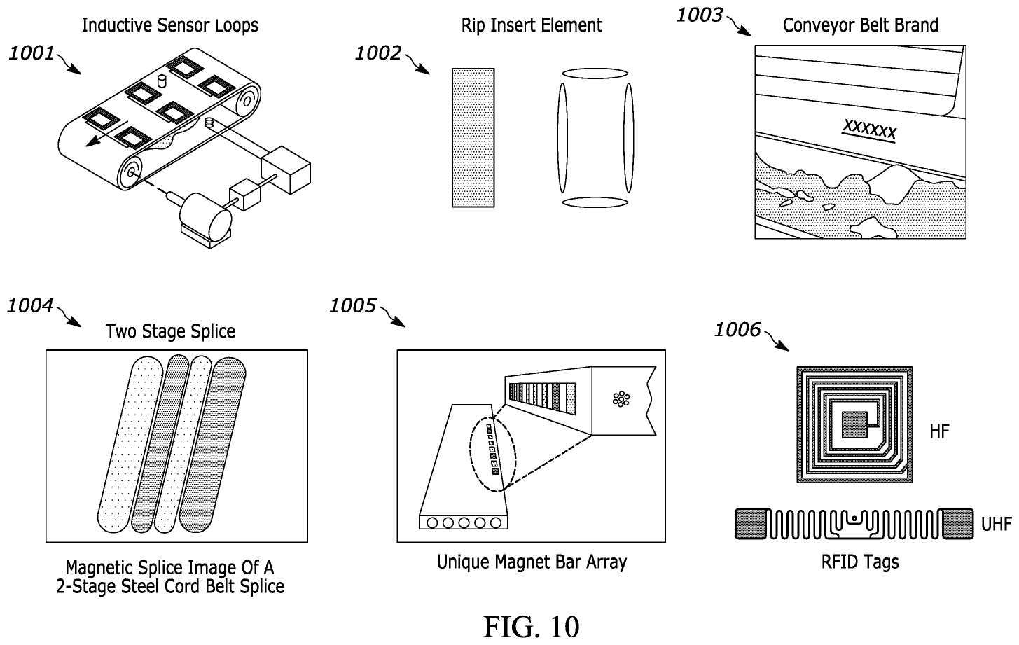

FIG. 10 is a diagram illustrating various references for conveyor belts that can be utilized in accordance with one or more embodiments.

The references can be used to provide location and/or position information for the system 100.

The references include, inductive sensor loops 1001, rip insert elements 1002, belt brand identification 1003, splices 1004, magnet bar arrays 1005, tags 1006 and the like.

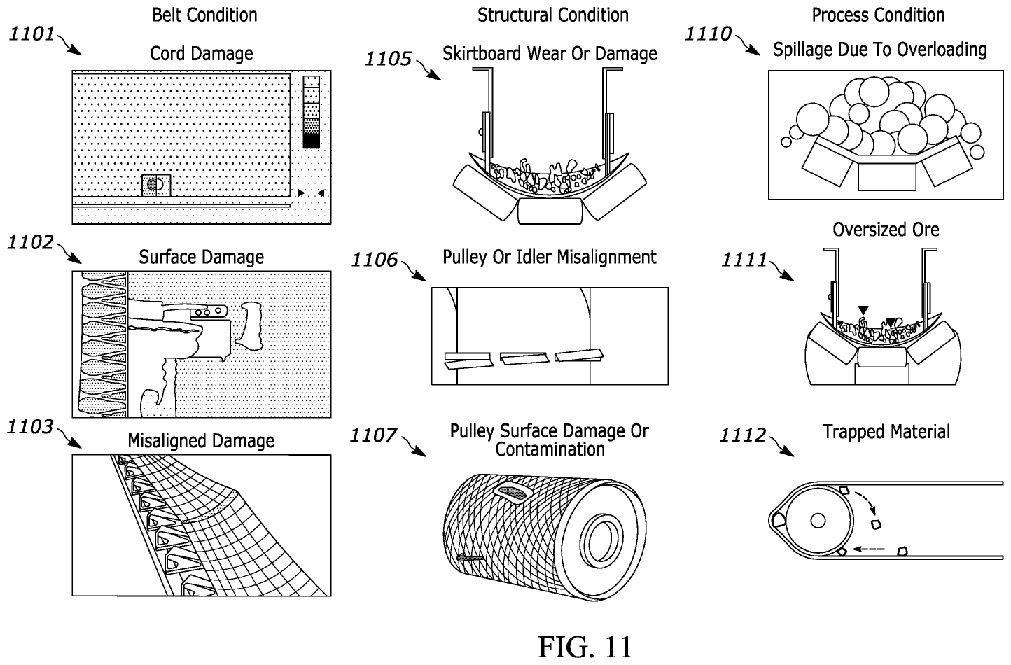

FIG. 11 is a diagram illustrating example conditions that can be employed with the system 100 in accordance with one or more embodiments.

The belt conditions include cord damage 1101, surface damage 1102, misaligned splice 1103 and the like.

The structural conditions include skirtboard wear or damage 1105, pulley or idler misalignment 1106, pulley surface damage 1107 and the like.

The process conditions include spillage or overloading 1110, oversized ore 1111, trapped material 1112 and the like.

In some aspects, the techniques described herein relate to a conveyor belt monitoring system for synchronizing belt condition, conveyor system condition and process conditions, the system including: a plurality of sensors to measure belt conditions, process conditions and conveyor structure conditions and provide as workflow data; one or more location sensors of the plurality of sensors to provide belt position data; a memory storage; an interface; circuitry including one or more processors configured to: synchronize process data, belt condition data, and conveyor system data and location data into a synchronization data set; detect an event based on the synchronization data and the operating process tolerances; correlate the detected event with the synchronization data as correlated data; and analyze the correlated data.

In some aspects, the techniques described herein relate to a system, the circuitry further configured to develop one or more causes for the detected event based on the correlated data.

In some aspects, the techniques described herein relate to a system, the circuitry further configured to relate the event to one or more of process conditions, conveyor conditions, and/or belt conditions.

In some aspects, the techniques described herein relate to a system, wherein the synchronization data includes a spatial reference of the belt location.

In some aspects, the techniques described herein relate to a system, whereby a synchronization signal is provided by at least one of the sensors.

In some aspects, the techniques described herein relate to a system, the one or more sensors positioned along the conveyor system determine the transverse belt position relative to the centerline of conveyor structure.

In some aspects, the techniques described herein relate to a system, the circuitry further configured to detect reference locations based on the belt location data.

In some aspects, the techniques described herein relate to a system, the memory storage stores operating process tolerances.

In some aspects, the techniques described herein relate to a system, where the system is further configured to capture corrective action events to monitor for the overall impact of these actions to the belt, process or system.

In some aspects, the techniques described herein relate to a system, where the system is further configured to capture the confirmation feedback of the correlated output to enhance machine learning algorithms.

In some aspects, the techniques described herein relate to a system, where the system is further configured to utilize digital twin models to further generate, evaluate, prioritize and validate the recommended corrective actions.

In some aspects, the techniques described herein relate to a system, where the digital twin model is used to predict trends and proactive maintenance actions to optimize conveyance processes.

In some aspects, the techniques described herein relate to a system, where the system is further configured to provide real world data as feedback to improve the digital twin model.

The foregoing description of the embodiments has been provided for purposes of illustration and description. Example embodiments are provided so that this disclosure will be sufficiently thorough and will convey the scope to those who are skilled in the art. Numerous specific details are set forth such as examples of specific components, devices, and methods, to provide a thorough understanding of embodiments of the disclosure but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an Application Specific Integrated Circuit, a Digital Signal Processor, a Field Programmable Gate Array, a Programmable Logic Controller, a Complex Programmable Logic Device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second”, and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “adjacent”, “outer”, “beneath”, “below”, “lower”, “above”, “upper”, and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A conveyor belt monitoring system for synchronizing belt condition, conveyor system condition and process conditions, the system comprising:
a plurality of sensors to measure belt conditions, process conditions and conveyor structure conditions and provide as workflow data;
one or more location sensors of the plurality of sensors to provide belt position data;
a memory storage;
an interface;
circuitry comprising one or more processors configured to:
synchronize process data, belt condition data, and conveyor system data and location data into a synchronization data set;
detect an event based on the synchronization data and the operating process tolerances;
correlate the detected event with the synchronization data as correlated data; and
analyze the correlated data.

2. The system of claim 1, the circuitry further configured to develop one or more causes for the detected event based on the correlated data.

3. The system of claim 2, the circuitry further configured to relate the event to one or more of process conditions, conveyor conditions, and/or belt conditions.

4. The system of claim 1, wherein the synchronization data includes a spatial reference of the belt location.

5. The system of claim 4, whereby a synchronization signal is provided by at least one of the sensors.

6. The system of claim 1, the one or more sensors positioned along the conveyor system determine the transverse belt position relative to the centerline of conveyor structure.

7. The system of claim 1, the circuitry further configured to detect reference locations based on the belt location data.

8. The system of claim 1, the memory storage stores operating process tolerances.

9. The system of claim 1, where the system is further configured to capture corrective action events to monitor for the overall impact of these actions to the belt, process or system.

10. The system of claim 1, where the system is further configured to capture the confirmation feedback of the correlated output to enhance machine learning algorithms.

11. The system of claim 9, where the system is further configured to utilize digital twin models to further generate, evaluate, prioritize and validate the recommended corrective actions.

12. The system of claim 11, where the digital twin model is used to predict trends and proactive maintenance actions to optimize conveyance processes.

13. The system of claim 11, where the system is further configured to provide real world data as feedback to improve the digital twin model.

14. The system of claim 1, further comprising a cloud server coupled to the interface.

15. A conveyor belt monitoring system for synchronizing belt condition, conveyor system condition and process conditions, the system comprising:
a plurality of sensors to measure belt conditions, process conditions and conveyor structure conditions and provide as workflow data;
one or more location sensors of the plurality of sensors to provide belt position data;
a memory storage;
an interface;
circuitry comprising one or more processors configured to:
synchronize process data, belt condition data, and conveyor system data and location data into a synchronization data set;
detect an event based on the synchronization data and the operating process tolerances;
correlate the detected event with the synchronization data as correlated data;
analyze the correlated data;
develop one or more causes for the detected event based on the correlated data;
relate the event to one or more of process conditions, conveyor conditions, and/or belt conditions; and
wherein the synchronization data set includes a spatial reference of the belt location.
